(19) United States
(12) Patent Application Publication
(10) Pub. No.: US 2016/0275669 A1
(43) Pub. Date: Sep. 22, 2016

(54) DEFECT INSPECTION APPARATUS, MANAGEMENT METHOD OF DEFECT INSPECTION APPARATUS AND MANAGEMENT APPARATUS OF DEFECT INSPECTION APPARATUS

(71) Applicant: KABUSHIKI KAISHA TOSHIBA, Tokyo (JP)

(72) Inventors: Ryoichi HIRANO, Tokyo (JP); Susumu Ilda, Yoshikawa (JP)

(21) Appl. No.: 14/817,780

(22) Filed: Aug. 4, 2015

(30) Foreign Application Priority Data
Mar. 16, 2015 (JP) 2015-052346

(51) Int. Cl. G06T 7/00; G06K 9/62

(52) U.S. Cl. CPC G06T 7/0004; G06K 9/6202; G06T 2207/30148

(57) ABSTRACT

According to one embodiment, a management method of a defect inspection apparatus, includes generating, with respect to a plurality of measurement points of a measurement target, difference values between signals obtained from an image of the measurement target and signals obtained from a reference image, generating a frequency distribution of the difference values, and determining whether the frequency distribution satisfies a predetermined condition.

### CROSS-REFERENCE TO RELATED APPLICATIONS

This application is based upon and claims the benefit of priority from Japanese Patent Application No. 2015-052346, filed Mar. 16, 2015, the entire contents of which are incorporated herein by reference.

### FIELD

Embodiments described herein relate generally to a defect inspection apparatus, a management method of a defect inspection apparatus and a management apparatus of a defect inspection apparatus.

### BACKGROUND

In association with the miniaturization of the pattern of semiconductor devices (semiconductor integrated circuit devices), the size of the defect to be detected in the defect inspection of a photomask or a semiconductor wafer is reduced. Thus, a high-sensitive defect inspection is becoming important.

However, when the size of the defect to be detected is reduced, it is difficult to distinguish the signal obtained from the defect from a noise component (false defect). In particular, when the characteristics of the defect detection apparatus are changed, it is more difficult to distinguish the signal obtained from the defect from a noise component.

In consideration of these factors, the desired is a management method and a management apparatus of a defect inspection apparatus capable of assuredly distinguishing the signal obtained from the defect to be detected from a noise component.

### BRIEF DESCRIPTION OF THE DRAWINGS

FIG. 1 schematically shows a structure of a defect inspection apparatus according to an embodiment.

FIG. 2 shows an inspection target die and a reference die according to the embodiment.

FIG. 3 shows the relationship between the defect size and a defect detection signal according to the embodiment.

FIG. 4 is a flowchart showing a management method of the defect inspection apparatus according to the embodiment.

FIG. 5 shows a measurement target die and a reference die according to the embodiment.

FIG. 6 shows image acquisition areas according to the embodiment.

FIG. 7 shows the frequency distribution of difference values according to the embodiment.

FIG. 8 shows the frequency distribution of difference values and a defect signal according to the embodiment.

FIG. 9 shows the frequency distribution of difference values and a defect signal according to the embodiment.

FIG. 10 schematically shows a structure of a modification example of the defect inspection apparatus according to the embodiment.

### DETAILED DESCRIPTION

In general, according to one embodiment, a management method of a defect inspection apparatus, includes: generating, with respect to a plurality of measurement points of a measurement target, difference values between signals obtained from an image of the measurement target and signals obtained from a reference image; generating a frequency distribution of the difference values; and determining whether the frequency distribution satisfies a predetermined condition.

Embodiments will be described hereinafter with reference to the accompanying drawings.

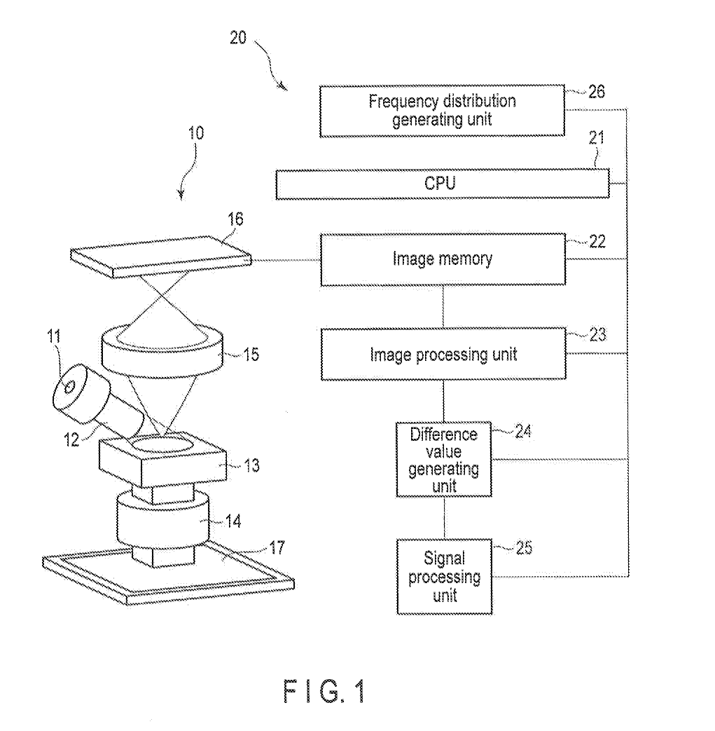

FIG. 1 schematically shows a structure of a defect inspection apparatus according to an embodiment.

As shown in FIG. 1, the defect inspection apparatus mainly comprises an image acquisition unit 10 and a defect determination unit 20.

The image acquisition unit 10 comprises an electron beam illumination source 11, an illumination optical system 12, a beam separation unit 13, an imaging optical system to cathode lens 14 and an object lens 15) and an imaging sensor 16.

The defect determination unit 20 comprises a CPU 21, an image memory 22, an image processing unit 23, a difference value generating unit 24, a signal processing unit 25 and a frequency distribution generating unit 26.

In the defect inspection apparatus shown in FIG. 1, a defect is inspected in the following manner.

The electron beam emitted from the electron beam illumination source 11 is applied to the surface of a lithography mask (for example, a photomask) 17 placed on a stage not shown) via the illumination optical system 12 and the beam separation unit 13. In the present embodiment, a secondary electron is generated from the surface of the mask 17 by applying an electron beam to the mask 17. A secondary electron image corresponding to the circuit pattern formed on the surface of the mask 17 is generated. The secondary electron image is formed on the imaging sensor 16 via the beam separation unit 13 and the imaging optical system (the cathode lens 14 and the object lens 15).

When the pattern formed on the mask 17 is inspected according to a die-to-die system, the image of the whole surface of the mask 17 is obtained by scanning the mask 17 in a y-direction and applying step movement to the mask 17 in an x-direction based on an instruction from the CPU 21.

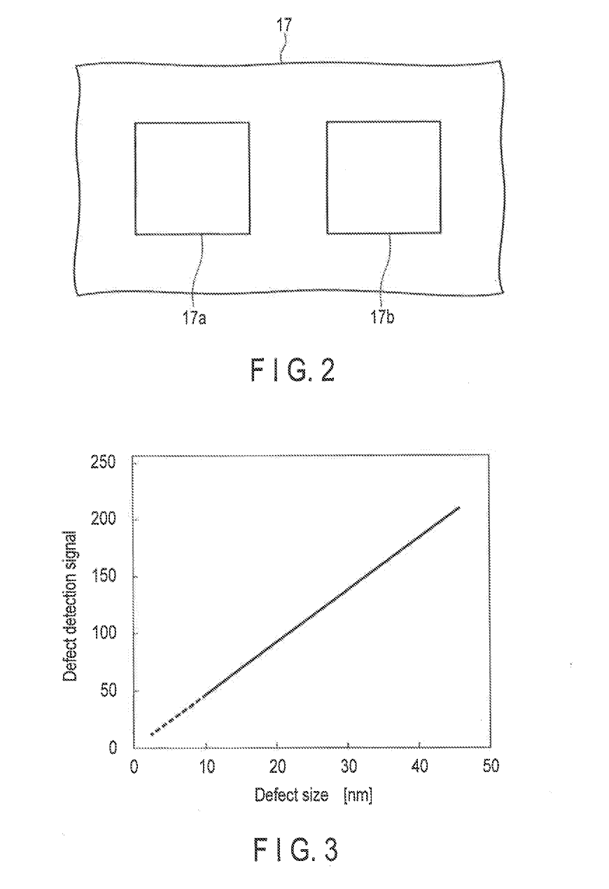

As shown in FIG. 2, the mask 17 includes an inspection target die 17a and a reference die 17b. The circuit pattern included in the inspection target die 17a is the same as the circuit pattern included in the reference die 17b. The image data of the inspection target die 17a and the in data of the reference die 17b are stored in the image memory 22.

A predetermined process (the enhancement process of a defect signal and the reduction process of a noise signal) is applied by the image processing unit 23 to the image data of the inspection target die 17a and the image data of the reference die 17b. The image data to which the predetermined process was applied is transferred to the difference value generating unit 24. Difference data between the image data of the inspection target die 17a and the image data of the reference die 17b is generated. The difference data is transferred to the signal processing unit 25. The signal processing unit 25 determines whether or not the value (difference value) of the difference signal included in the difference data is greater than a predetermined threshold. When the signal processing unit 25 determines that the difference value is greater than the predetermined threshold, the CPU 21 determines that a defect is present in the portion whose difference value is determined as being greater than the predetermined threshold.

FIG. 3 shows the relationship between the defect size and a defect detection signal. The defect detection signal corresponds to the above-described difference value. As shown in FIG. 3, the value of the defect detection signal is decreased with reduction of the defect size. Thus, it is possible to define the value (difference value) of the defect detection signal in accordance with the size of the defect to be detected in advance.

However, when the size of the defect to be detected is reduced, it is difficult to distinguish the defect detection signal from a noise component (false detect). In particular, if the characteristics of the defect detection apparatus are changed, it is more difficult to distinguish the defect detection signal from a noise component (false detect). For example, it is possible to obtain the necessary defect detection sensitivity by calibrating the characteristics of the defect detection apparatus with use of a standard substrate for calibrating the defect detection sensitivity. However, in this case, the calibration process is not easy since a standard substrate needs to be used.

In the present embodiment, the following method is employed.

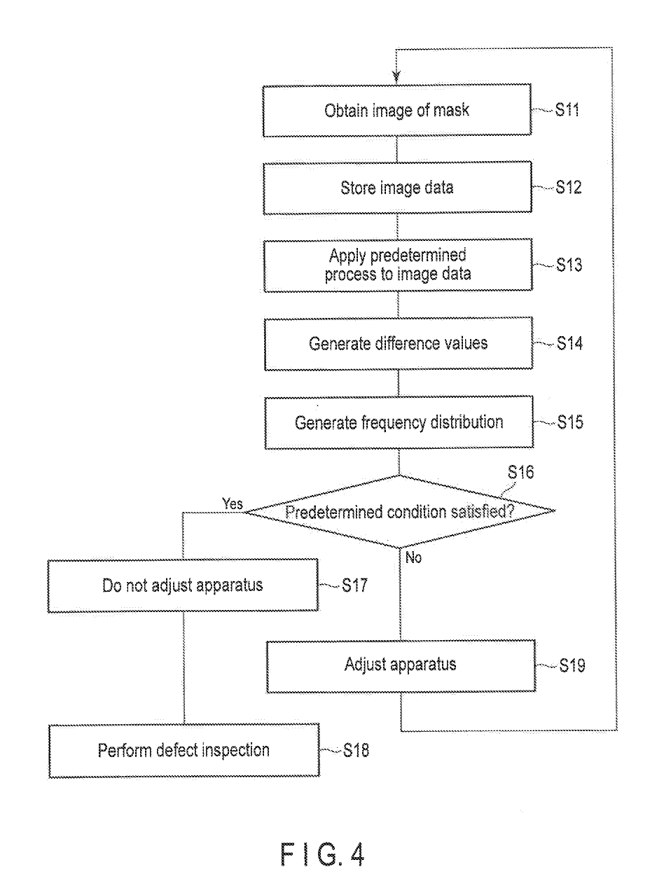

FIG. 4 is a flowchart showing the management method of the defect inspection apparatus according to the present embodiment.

First, the image of the lithography mask 17 is obtained by the image acquisition unit 10 shown in FIG. 1 (S11).

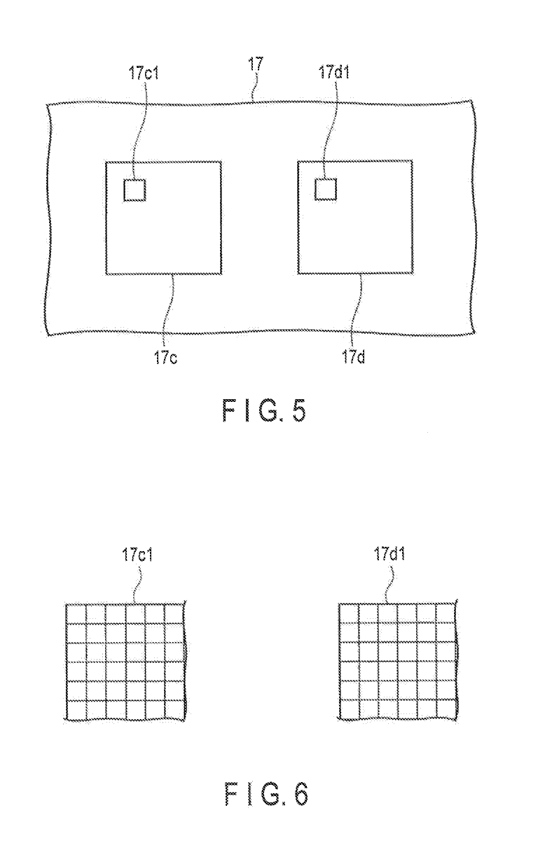

As shown in FIG. 5, the mask 17 includes a measurement target die 17c and a reference die 17d. The circuit pattern included in the measurement target die 17c is the same as the circuit pattern included in the reference die 17d. The measurement target die 17c includes image acquisition area 17c1. The reference die 17d includes image acquisition area 17d1. Image acquisition area 17c1 and image acquisition area 17d1 are allocated so as to correspond to each other in the measurement target: die 17c and the reference die 17d. The circuit pattern included in image acquisition area 17c1 is the same as the circuit pattern included in image acquisition area 17d1. No detectable defect is present in image acquisition area 17c1 or image acquisition area 17d1.

As shown in FIG. 6, when image data is obtained, both image acquisition area 17c1 and image acquisition area 17d1 are divided in a mesh-like state. An image signal (strength signal) is obtained based on each division point as a measurement point. The division points of image acquisition area 17c1 correspond to the division points of image acquisition area 17d1.

The image data obtained from image acquisition area 17c1 and the image data obtained from image acquisition area 17d1 are stored in the image memory 22 (S12).

A predetermined process (the enhancement process of a defect signal and the reduction process of a noise signal) is applied by the image processing unit 23 to the image data obtained from image acquisition area 17c1 and image acquisition area 17d1 (S13).

The image data to which the predetermined process was applied is transferred to the difference value generating unit 24. The difference value generating unit 24 generates the difference values between the signals obtained from the image of the measurement target die 17c and the signals obtained from the reference image with respect to a plurality of division points (measurement points) (S14). In other words, the difference value generating unit 24 generates the difference value between the signal strength of each division point of image acquisition area 17c1 and the signal strength of each division point of image acquisition area 17d1.

As is clear from the above description, the reference image obtained from image acquisition area 17d1 of the reference die 17d is the image of a pattern corresponding to the pattern of image acquisition area 17c1 of the measurement target die 17c. No detectable defect is present in image acquisition area 17c1 or image acquisition area 17d1. In other words, no detectable defect is present in the area including a plurality of measurement points (division points). The difference values generated in the difference value generating unit 24 do not include the difference caused by a defect and only include the difference caused by a noise component. The noise component includes an error component caused by the image acquisition unit 10 or the edge roughness of the mask pattern.

The difference values of a plurality of measurement points generated by the difference value generating unit 24 are transferred to the frequency distribution generating unit 26. The frequency distribution generating unit 26 generates the frequency distribution of the difference values (S15). With respect to each of the division points (measurement points) shown in FIG. 6, the difference value between the image signal of image acquisition area 17c1 and the image signal of image acquisition area 17d1 is obtained. Thus, the frequency distribution of the generated difference values is generated.

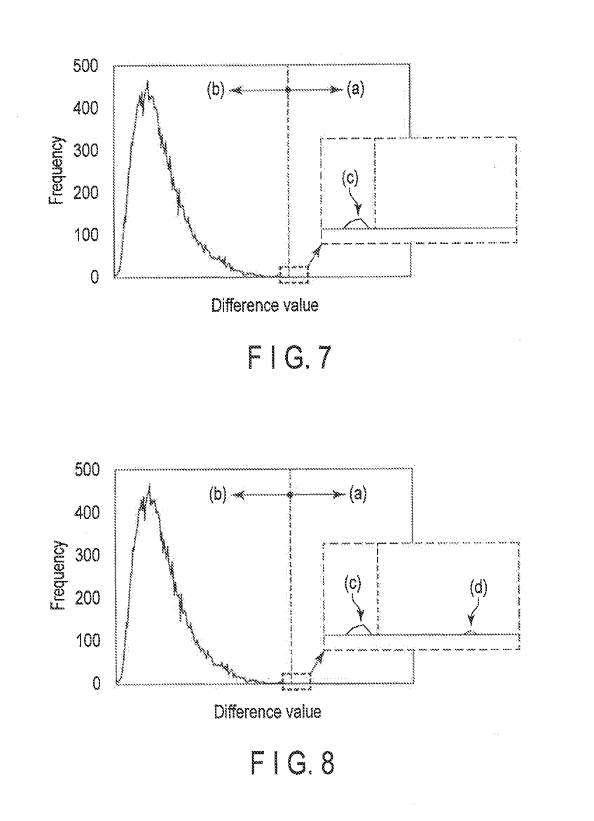

FIG. 7 shows the frequency distribution of difference values generated by the frequency distribution generating unit 26. As shown in FIG. 7, the frequency increases with increase in the difference value. After the frequency reaches the maximum value, the frequency decreases and ultimately becomes zero.

The difference values are not included in the area (a) of FIG. 7. All of the difference values are included in the area (b) of FIG. 7. FIG. 7(c) shows an enlarged view of the area including the maximum value of the difference values.

Next, the CPU 21 determines whether or not the distribution frequency of difference values satisfies a predetermined condition (S16).

Specifically, the frequency distribution of difference values is compared with the standard frequency distribution in order to obtain the comparison result. The standard frequency distribution corresponds to an ideal frequency distribution in a case where, for example, the error component caused by the image acquisition unit 10 is zero. Whether or not the frequency distribution of difference values satisfies the predetermined condition is determined by determining whether or not the obtained comparison result satisfies a predetermined condition.

More specifically, whether or not the average value and the standard deviation of the frequency distribution satisfy a predetermined condition is determined. As shown in FIG. 7, the frequency distribution of difference values can be approximated by the distribution of the probability density function such as gamma distribution. The average value and the standard deviation of the frequency distribution of difference values are calculated. The calculated average value and standard deviation are compared with the average value and the standard deviation of the standard frequency distribution. Whether or not the comparison result satisfies a predetermined condition is determined.

When it is determined that the frequency distribution of difference values satisfies the predetermined condition, the defect inspection apparatus is not adjusted (S17). When the predetermined condition is satisfied, the difference value based on a detectable defect of the mask is considered as being greater than the maximum value of the difference values obtained in step S14. In other words, when the predetermined condition is satisfied, the difference value based on a detectable defect of the mask is considered as being included in the area (a) of the frequency distribution obtained in step S15. FIG. 8 shows this type of case. The difference values (d) of defect signals are included in the area (a). Thus, defects are detectable without adjusting the defect inspection apparatus. In this case, subsequently, the defect inspection of the mask 17 may be performed by the defect inspection apparatus (S18).

When it is determined that the frequency distribution of difference values does not satisfy the predetermined condition, the defect inspection apparatus is adjusted such that the frequency distribution satisfies the predetermined condition (S19). Specifically, the defect inspection apparatus is adjusted such that the maximum value of the difference values between the signals obtained from the image of the measurement target die 17c and the signals obtained from the reference image of the reference die 17d is less than a predetermined value based on the defect to be detected. This type of case is explained in detail below.

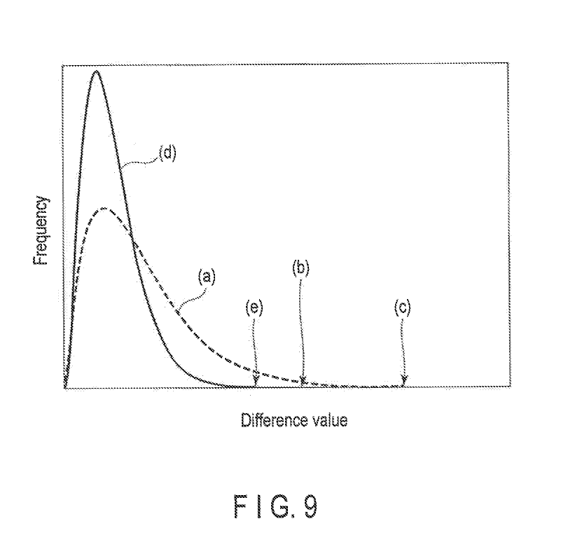

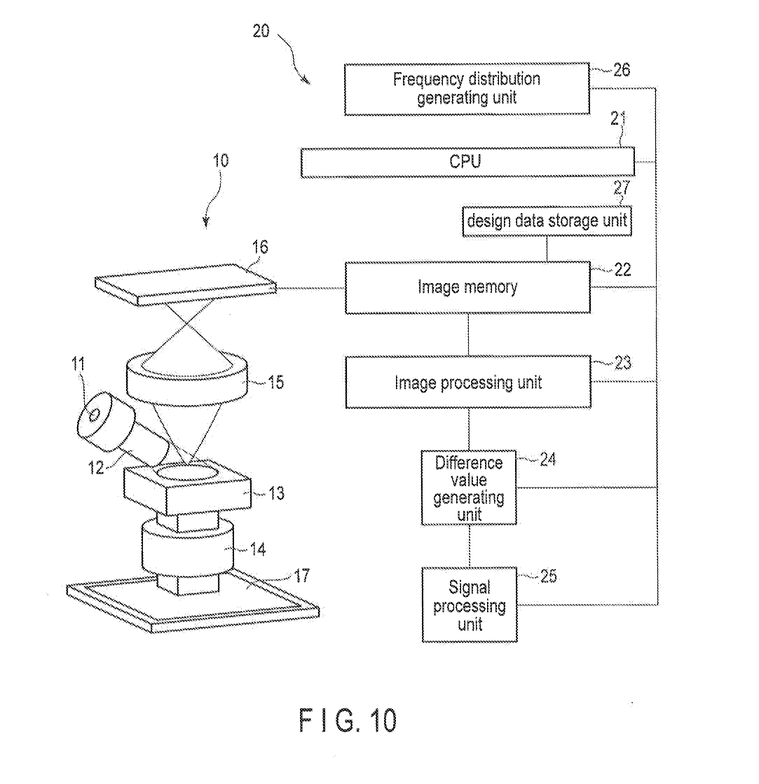

There is a case where the frequency distribution shown in (a) of FIG. 9 is obtained because of the error component of the image acquisition unit 10 of the defect inspection apparatus. In this case, the difference value (b) based on a defect of the mask is less than the maximum difference value (c) of the frequency distribution. Thus, it is not possible to distinguish the defect of the mask from the error component (noise component) of the defect inspection apparatus.

A typical example of the error component of the defect inspection apparatus is the brightness distribution of an illumination area. If the brightness distribution of the illumination area of the measurement target die 17c is different from the brightness distribution of the illumination area of the reference die 17d, an error component (noise component) is generated because of the difference in brightness distribution. Normally, the brightness distribution of an illumination area changes gradually. The brightness distribution can be accurately approximated by, for example, a polynomial expression. If the image signal is corrected by using the approximate expression of the brightness distribution, the distribution characteristics (d) shown in FIG. 9 are obtained. In such distribution characteristics, the difference value (b) of the defect signal is greater than the maximum difference value (e) of the frequency distribution.

The CPU 21 generates an adjustment guideline based on the approximate expression of the brightness distribution. The defect inspection apparatus is adjusted in accordance with an instruction from the CPU 21 based on the adjustment guideline. After this adjustment, the process returns to step S11 and executes steps S11 to S16. In this way, the maximum difference value of the frequency distribution can be less than the difference value of the defect signal. It is possible to distinguish the defect of the mask from the noise component.

As described above, in the present embodiment, the frequency distribution of difference values between the signals obtained from the image of the measurement target and the signals obtained from the reference image is generated. Whether or not the frequency distribution satisfies a predetermined condition is determined. If it is determined that the frequency distribution does not satisfy the predetermined condition, the defect inspection apparatus is adjusted such that the frequency distribution satisfies the predetermined condition. In this way, it is possible to assuredly distinguish the signal obtained from the defect to be detected from the noise component.

In the present embodiment, the measurement target is included in the lithography mask in which the defect inspection is actually performed. Therefore, there is no need to use a standard substrate for calibrating the defect detection sensitivity, etc. It is possible to rapidly and easily perform the calibration process (adjustment process) of the defect inspection apparatus.

In the above embodiment, difference values are generated according to a die-to-die system. However, difference values may be generated according to a die-to-database system.

FIG. 10 schematically shows the structure of a modification example of the defect inspection apparatus when difference values are generated according to a die-to-database system. As the basic matters are the same as those of the above embodiment, the explanation of such matters is omitted.

In this modification example, a design data storage unit 27 is provided in addition to the structure of FIG. 1. The image data of the reference die is generated based on the setting data stored in the design data storage unit 27. The generated image data of the reference die is stored in the image memory 22. The other basic operations are the same as chose of the above embodiment.

In this modification example, similarly to the above embodiment, the frequency distribution of the difference values between the signals obtained from the image of the measurement target and the signals obtained from the reference image is generated. Whether or not the frequency distribution satisfies a predetermined condition is determined. When it is determined that the frequency distribution does not satisfy the predetermined condition, the defect inspection apparatus is adjusted such that the frequency distribution satisfies the predetermined condition. In this modification example, an effect similar to that of the above embodiment can be obtained.

In the above embodiment, no detectable defect is present in image acquisition area 17c1 or image acquisition area 17d1. However, a detectable defect may be present in image acquisition area 17c1 and image acquisition area 17d1. Even if detectable defects are present in the image acquisition areas, as long as the number of detectable defects is small, the frequency distribution of difference values does not greatly change compared with the case where a detectable defect is not present. Even in such a case, a method similar to that of the above embodiment can be applied by comparing the frequency distribution of difference values with the standard frequency distribution.

In the above embodiment, all of the division points of image acquisition area 17c1 and image acquisition area 17d1 are measurement points, and difference values are generated with respect to all of the division points. However, all of the division points may not be measurement points. Even in this case, a method similar to that of the above embodiment can be applied by comparing the frequency distribution of difference values with the standard frequency distribution with respect to the measurement points.

In the above embodiment, the measurement target is included in the lithography mask. However, the measurement target may be included in the semiconductor substrate (semiconductor wafer). The above method can be also used in a case where a defect formed on the semiconductor substrate is inspected.

In the above embodiment, the image of the measurement target is obtained by applying an electron beam to the surface of the measurement target. However, instead of an electron beam, light such as deep ultraviolet (DUV) light may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management method of a defect inspection apparatus, the method comprising:
generating, with respect to a plurality of measurement points of a measurement target, difference values between signals obtained from an image of the measurement target and signals obtained from a reference image;
generating a frequency distribution of the difference values; and
determining whether the frequency distribution. satisfies a predetermined condition.

2. The method of claim 1, wherein
the determining whether the frequency distribution satisfies the predetermined condition includes:
obtaining a comparison result by comparing the frequency distribution with a standard frequency distribution; and
determining whether the comparison result satisfies a predetermined condition.

3. The method of claim 1, wherein
the determining whether the frequency distribution satisfies the predetermined condition includes
determining whether an average value and a standard deviation of the frequency distribution satisfy a predetermined condition.

4. The method of claim 1, wherein
the defect inspection apparatus is adjusted when it is determined that the frequency distribution does not satisfy the predetermined condition.

5. The method of claim 4, wherein
the defect inspection apparatus is adjusted such that a maximum value of the difference values is less than a predetermine value based on a defect to be detected.

6. The method of claim 1, wherein
no detectable defect is present in an area including the plurality of measurement points.

7. The method of claim 1, wherein
the measurement target is included in a lithography mask or a semiconductor substrate in which a defect inspection is actually to be performed.

8. The method of claim 1, wherein
the reference image is an image based on a pattern corresponding to a pattern of the measurement target.

9. The method of claim 1, wherein
the difference values are generated according to a die-to-die inspection.

10. The method of claim 1, wherein
the difference values are generated according to a die-to-database inspection.

11. The method of claim 1, wherein
the image of the measurement target is obtained by applying an electron beam or light to a surface of the measurement target.

12. A defect inspection apparatus comprising an image acquisition unit acquiring an image of a measurement target and a defect determination unit,
the defect determination unit comprising:
a difference value generating unit which generates, with respect to a plurality of measurement points of the measurement target, difference values between signals obtained from the image of the measurement target and signals obtained from a reference image;
a frequency distribution generating unit which generates a frequency distribution of the difference values; and
a determination unit which determines whether the frequency distribution satisfies a predetermined condition.

13. The apparatus of claim 12, wherein
the determination unit obtains a comparison result by comparing the frequency distribution with a standard frequency distribution, and determines whether the comparison result satisfies a predetermined condition.

14. The apparatus of claim 12, wherein
the determination unit determines whether an average value and a standard deviation of the frequency distribution satisfy a predetermined condition.

15. The apparatus of claim 12, wherein
an adjustment guideline in which the frequency distribution satisfies the predetermined condition is generated when the determination unit determines that the frequency distribution does not satisfy the predetermined condition.

16. The apparatus of claim 15, wherein
a maximum value of the difference values is less than a predetermined value based on a defect to be detected in the generated adjustment guideline.

17. The apparatus of claim 12, wherein
the measurement target is included in a lithography mask or a semiconductor substrate in which a defect inspection is actually to be performed.

18. The apparatus of claim 12, wherein
the reference image is an image based on a pattern corresponding to a pattern of the measurement target.

19. A management apparatus of a defect inspection apparatus, the management apparatus comprising:
a difference value generating unit which generates, with respect to a plurality of measurement points of a measurement target, difference values between signals obtained from an image of the measurement target and signals obtained from a reference image;
a frequency distribution generating unit which generates a frequency distribution of the difference values; and
a determination unit which determines whether the frequency distribution satisfies a predetermined condition.

20. The apparatus of claim 19, wherein
the determination unit obtains a comparison result by comparing the frequency distribution with a standard frequency distribution, and determines whether the comparison result satisfies a predetermined condition.
